(19) United States
(12) Patent Application Publication
(10) Pub. No.: US 2013/0073386 A1
(43) Pub. Date: Mar. 21, 2013

(54) SYSTEMS AND METHODS FOR GENERATING FINANCIAL INSTITUTION PRODUCT OFFER PROPOSALS

(71) Applicants: David T. Rose, Cumming, GA (US); Donald Henry Hopper, JR., Stone Mountain, GA (US); Hong Huang, Atlanta, GA (US)

(72) Inventors: David T. Rose, Cumming, GA (US); Donald Henry Hopper, JR., Stone Mountain, GA (US); Hong Huang, Atlanta, GA (US)

(73) Assignee: FISERV, INC., Brookfield, WI (US)

(21) Appl. No.: 13/237,583

(22) Filed: Sep. 20, 2011

(51) Int. Cl. G06Q 30/00; G06Q 40/00

(52) U.S. Cl. 705/14.53

(57) ABSTRACT

Systems and methods for generating financial institution product offer proposals are provided. Historical information associated with a customer of a first financial institution may be evaluated to identify transaction information including at least one of (i) a set of one or more payments directed to a second financial institution different from the first financial institution or (ii) a set of one or more bills received from the second financial institution. Based at least in part upon an evaluation of the transaction information, a customer candidacy for an offer associated with a first financial institution product may be determined, and an offer proposal for the first financial institution product may be generated. The generated offer proposal or an offer for the first financial institution product may then be transmitted to a recipient.

### FIELD OF THE INVENTION

Aspects of the invention relate generally to the generation of financial institution product offer proposals, and more particularly, to systems and methods for generating financial institution product offer proposals based upon an analysis of transaction history information associated with financial institution customers.

### BACKGROUND OF THE INVENTION

It is common for financial institution customers, such as individuals and small businesses, to have multiple banking relationships. For example, while a primary demand deposit account (DDA) may be maintained at a primary financial institution, various loan accounts, credit card accounts, savings accounts, and investment accounts may be maintained at other financial institutions. Financial institutions are constantly seeking opportunities to increase revenues. In many situations, revenue may be increased by enticing an existing customer to establish a new relationship with a financial institution. For example, revenue may be increased by enticing a customer to refinance an installment loan account currently held by another financial institution to a loan account provided by the primary financial institution. Thus, there is an opportunity for systems and methods for generating financial product offer proposals on behalf of financial institutions.

### BRIEF DESCRIPTION OF THE DRAWINGS

Reference will now be made to the accompanying drawings, which are not necessarily drawn to scale, and wherein:

FIG. 1 illustrates a block diagram of an example system that supports the generation of financial institution product offer proposals and/or product offers, according to an illustrative embodiment of the invention.

FIG. 2 illustrates an example data flow for generating and transmitting a financial institution product offer proposal and/or product offer, according to an illustrative embodiment of the invention.

FIGS. 3A and 3B illustrate a flow diagram of an example method for evaluating transaction information in order to selectively generate financial institution product offer proposals and/or product offers, according to an illustrative embodiment of the invention.

### DETAILED DESCRIPTION OF THE INVENTION

The invention will now be described more fully hereinafter with reference to the accompanying drawings, in which example embodiments of the invention are shown. This invention may, however, be embodied in many different forms and should not be construed as limited to the example embodiments set forth herein; rather, these example embodiments are provided so that this disclosure will be thorough and complete, and will fully convey the scope of the invention to those of ordinary skill in the art. Like numbers refer to like elements throughout.

Embodiments of the invention may provide systems and methods for generating financial institution product offer proposals. In one example embodiment, historical information associated with a customer of a financial institution may be analyzed or evaluated. In this regard, various transaction activities between the customer and one or more other financial institutions may be identified. For example, transaction information associated with one or more payments directed to a second financial institution and/or transaction information associated with one or more bills received from the second financial institution may be identified. Based at least in part upon an evaluation of the historical information and/or the identified transaction information, a determination may be made as to whether the customer is a candidate for an offer associated with a financial institution product. For example, a determination may be made as to whether the customer is a candidate for a loan offer proposal or a credit card offer proposal. In this regard, relatively targeted product offers may be made by financial institutions or on behalf of financial institutions to existing customers of the financial institutions.

It will be appreciated that the operations described herein, or at least a portion thereof, may be performed by a service provider, a financial institution, or a combination thereof on a periodic basis, based upon the identification of an event (e.g., a request to open a new account, a determination that an existing loan is approaching termination, etc.), and/or on an as-requested basis, according to an example embodiment of the invention. As one example, the service provider may operate as an application service provider (ASP) that allows a user of a financial institution computer to identify a customer for a product offer candidacy analysis and/or to provide a wide variety of parameters, business rules, and/or data to be taken into consideration when evaluating the customer. The results of the evaluations and/or analyses (e.g., identified product offer proposals) can then be transmitted to and/or accessed by a financial institution computer communicating with the service provider via one or more suitable networks. In certain embodiments, a service provider may provide product offer proposal and/or product offer functionality (e.g., the identification of product offer proposals, the delivery of product offers, etc.) to a plurality of financial institutions, according to an example embodiment of the invention. In other embodiments, the service provider can be a unit of a financial institution that provides the product offer proposal and/or product offer functionality to one or more units of the same financial institution, a subsidiary of the same financial institution, or other financial institution(s) via networked financial institution computers. Alternatively, the operations described herein may also be performed by suitable software running locally at a financial institution computer. In this regard, the financial institution computer can access, either locally or via a network, data for customers to be evaluated, as well as any configuration options or preferences for performing the evaluations.

I. System Overview

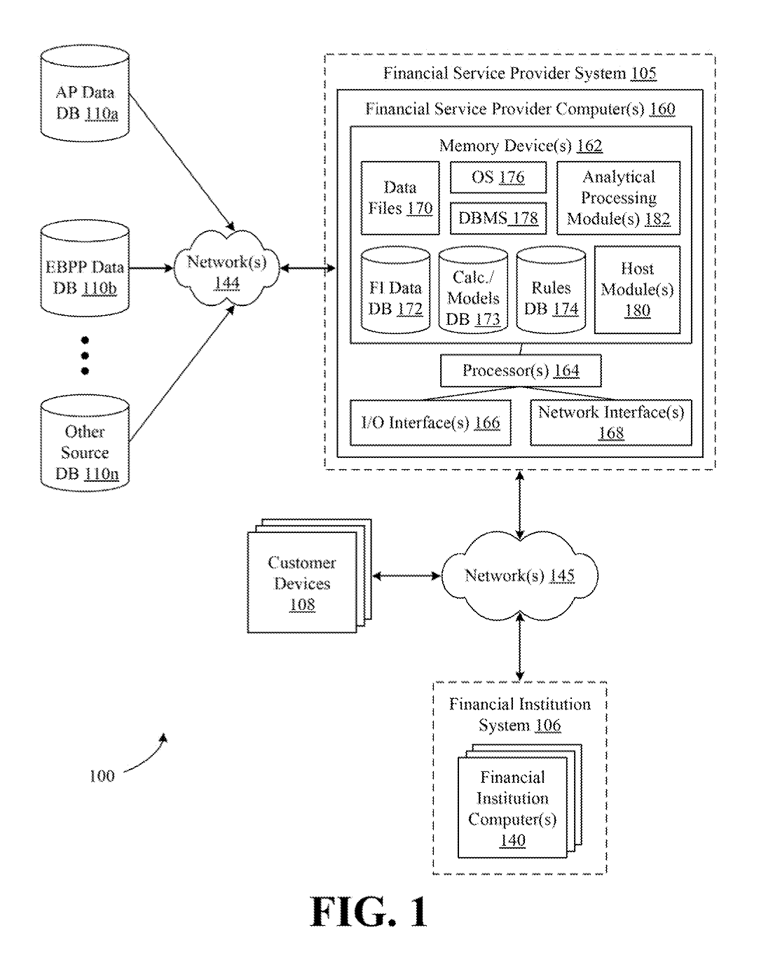

FIG. 1 illustrates a block diagram of an example system 100 that supports the evaluation of historical customer and/or transaction data and/or to generate financial institution product offer proposals, according to an illustrative embodiment of the invention. Although various computing devices and/or computers are illustrated in FIG. 1, it is appreciated that corresponding entities and/or individuals may be associated with each of the computers and/or devices illustrated. According to various embodiments, there may be: one or more financial service provider systems 105, each associated with one or more financial service provider computers 160 and potentially associated with a service provider entity, one or more financial institution systems 106, each associated with one or more financial institution computers 140, and/or one or more customer devices 108 associated with customers of the financial institutions. Each financial institution system 106 may be associated with a financial institution, such as but not limited to, a bank, thrift, credit union, or brokerage. According to various embodiments, there may be any number of each entity type, and each entity may be associated with any number of suitable computers, computing devices, and/or other devices. For simplicity, the entities, systems, computers, and/or devices may be referenced in the singular, but it is appreciated that the same description applies to embodiments including multiple entities, systems, computers, and/or devices. Similarly, for each of the computers described herein, it is appreciated that the computer may include any number of suitable components and/or functionalities. Moreover, although detailed descriptions of system components are provided for the financial service provider system 105, it is appreciated that any of the financial institution systems 106 may be configured in any suitable manner, which may be similar to that described herein for the financial service provider system 105. In this regard, the financial institution computers can include one or more memory devices, processors, input/output (I/O) interfaces, and network interfaces. The one or more memory devices may store computer-executable instructions, which may be accessed and executed by the one or more processors to provide the functionality described herein with respect to the financial institution computers.

As shown in FIG. 1, the financial service provider system 105, the financial institution system 106, and/or the customer devices 108 may be in communication with each other via one or more suitable networks 145, which, as described below, can include one or more separate or shared private and/or public networks, including the Internet, a public switched telephone network, one or more wide area networks, one or more local area networks, and/or a combination of any suitable networks. In addition, the financial service provider system 105, including at least one financial service provider computer 160, can have access to one or more databases 110a-n or other storage of data via one or more suitable networks 144, which may be the same as or different from networks 145. These components will now be discussed in further detail.

The financial service provider system 105 may include any number of financial service provider computers 160 that operate to obtain certain information associated with customers of one or more financial institutions, and further to evaluate at least a portion of the information in order to generate one or more financial institution product offer proposals. In certain embodiments, the financial service provider computers 160 may additionally or alternatively be configured to evaluate at least a portion of the information to generate financial institution product offers and/or to facilitate delivery of the generated offers to one or more of the customers. In addition, the one or more financial service provider computers 160 may communicate with any number of financial institution computers 140 to receive business rules, options, preferences, and/or constraints for determining eligibility for product offer proposals, for customizing product offer proposals, and/or for transmitting product offer proposals to any number of financial institution computers 140. A financial service provider computer 160 may be any suitable processor-driven device, such as, but not limited to, a server computer, a mainframe computer, one or more networked computers, a desktop computer, a personal computer, a digital assistant, a personal digital assistant, a digital tablet, an Internet appliance, an application-specific circuit, a microcontroller, a minicomputer, or any other processor-based device. The execution of suitable computer-implemented instructions by the financial service provider computer 160 may form a special purpose computer or other particular machine that is operable to facilitate the identification and/or generation of financial institution product offer proposals. Although a single financial service provider computer 160 is described herein, the operations and/or control of the financial service provider computer 160 may be distributed among any number of computers and/or processing components.

In addition to having one or more processors 164, the financial service provider computer 160 may include one or more memory devices 162, one or more input/output (I/O) interfaces 166, and one or more network interfaces 168. The memory devices 162 may be any suitable memory devices, for example, caches, read-only memory devices, random access memory devices, magnetic storage devices, removable storage devices, etc. Additionally, any number of logical data storage constructs may be stored as desired within the memory devices 162, such as a financial institution data database 172, a calculations and models database 173, a rules database 174, and/or any number of suitable databases. In addition or in the alternative, while databases 110a-n may be accessed via a network 144 in some embodiments, any of databases 110a-n may be stored within memory devices 162 without departing from example embodiments of the invention. The memory devices 162 may further store a wide variety of data, such as any number of data files 170. Additionally, the memory devices 162 may store executable instructions and/or various program modules utilized by the financial service provider computer 160, for example, an operating system (OS) 176, a database management system (DBMS) 178, one or more host modules 180, and/or one or more analytical processing modules 182.

The data files 170 and/or the various databases 172, 173, 174 may include any suitable data that facilitates the receipt and/or processing of data utilized in association with the identification of financial institution product offer proposals. For example, the data files 170 and/or the databases 172, 173, 174 may include data derived or received from databases 110a-n, any business rules, options, preferences and/or constraints received from one or more financial institution systems 106, and/or default business rules, options, preferences, and/or constraints, as well as processing results from the performed evaluations (e.g., recommended product offer proposals, etc.) that are transmitted to and/or otherwise made available to one or more financial institution systems 106.

In one example embodiment, the financial institution (FI) data database 172 may include historical data associated with customers of financial institutions. For example, for any given customer of a financial institution, the FI data database 172 may include historical data associated with payments directed to one or more other financial institutions (e.g., loan payments, credit card payments, etc.) and/or data associated with billing information for the customer with respect to one or more other financial institutions (e.g., bills and/or bill summary information issued on behalf of one or more other financial institutions for presentment to the customer). In certain embodiments, at least a portion of the information stored in the FI data database 172 may be obtained from one or more other databases, such as the AP data database 110a and/or the electronic bill presentment and payment (EBPP) data database 110b.

The calculations and models database 173 may include stored predictive models, calculation algorithms, and/or various rules utilized to evaluate historical customer data and/or a wide variety of other customer information. As desired, the predictive models may be utilized for a wide variety of different purposes. For example, predictive models may be utilized to process customer data in order to determine one or more customer indicators, customer factors, and/or customer values, such as a customer segment, an attrition propensity, a customer loyalty, a customer loan candidacy, an optimal product to be offered, and/or a percentage of a customer's business attributed to a financial institution. As another example, predictive models may be utilized to process historical transaction information in order to identify account numbers (e.g., loan account numbers, credit card account numbers, etc.) associated with prior payments and/or billing information. As yet another example, predictive models may be utilized to determine customized parameters for a product offering. Predictive models may be utilized for a wide variety of other purposes as desired in various embodiments. In some example embodiments, the calculations and models database 173 may store predictive models, rules, and/or calculation algorithms that may be modified without affecting associated software, while other predictive models, rules, and/or calculation algorithms may be “hard-coded” in associated software. For example, a predictive model may be hard-coded into the computer-executable instructions associated with an analytical processing module 182.

The rules database 174 may include stored rules and/or parameters that are utilized to facilitate the determination of a customer candidacy for a financial institution product offer proposal. The rules may include default rules and/or rules received by the financial service provider system 105 from another system, such as the financial institution system 106. For example, a financial institution employee may utilize a financial institution computer 140 to provide rules to the financial service provider computer 160. As another example, a set of rules and/or a rules file may be pushed to the financial service provider computer 160 by the financial institution computer 140 or pulled from the financial institution computer 140 by the financial service provider computer 160. Additionally, as an alternative to storing rules in the rules database 174, one or more rules may be hard-coded within an analytical process itself. For example, one or more rules may be hard-coded into the computer-executable instructions associated with an analytical processing module 182.

A wide variety of different types of rules may be utilized as desired in various embodiments of the invention. These rules include, but are not limited to, rules for identifying transaction information to be evaluated, rules for identifying relevant customer indicators, rules for evaluating customer indicators, rules for determining customer candidacy for an offer proposal, rules for performing additional analysis relating to a candidate proposal, rules for customizing an offer proposal for a customer, rules for transmitting an offer proposal to a financial institution system, rules for generating an offer, and/or rules for providing a generated offer to a customer. In certain embodiments, various sets of rules may be established for different evaluative purposes. Within each set of rules, various hierarchies and/or predetermined conditions associated with the application of the rules may be established.

Many variations of the data files 170, FI data database 172, calculations and models database 173, and/or rules database 174 are available in accordance with example embodiments of the invention. It is appreciated that the illustration of each of the various databases 172, 173, 174 as separate from the data files 170 and/or any other data storage means is provided for illustrative purposes, and that any data may be stored in any arrangement, separate or together with other data stored by the financial service provider computer 160.

The OS 176 may be a suitable software module that controls the general operation of the financial service provider computer 160. The OS 176 may also facilitate the execution of other software modules by the one or more processors 164, for example, the analytical processing modules 182, the DBMS 178, and/or the host module(s) 180. The OS 176 may be, but is not limited to, Microsoft Windows®, Apple OSX™, Linux, Unix, or a mainframe operating system. The DBMS 178 may be a suitable software module that facilitates storage and/or retrieval of information from the databases 172, 173, 174, as well as maintenance of the databases 172, 173, 174. The host modules 180 may include any number of suitable host modules that manage interactions and communications between the financial service provider system 105 and any number of external systems, such as the financial institution system 106 (e.g., financial institution computer 140). In this regard, the host module 180 can interface with other modules such as the analytical processing modules 182 in order to facilitate the receipt of data from databases 110a-n, as well as business rules, options, preferences, and/or constraints from the financial institution system 106; and manage requests from one or more financial institutions to evaluate customer information and/or requests to receive one or more generated product offer proposals. Additionally, in certain embodiments, the host modules 180 may be configured to generate and/or to present a wide variety of different interfaces and/or graphical user interfaces, such as one or more interfaces that facilitate the receipt of data and/or requests from, or a presentation of results or other information to, the financial institution system 106 and/or financial service provider system 105. As another example, in certain embodiments, different interfaces may be configured to present product offers to customers via the customer devices 108. An interface can be in the form of one or more browser-based or Internet-based Web pages, although interfaces can also be presented through specialized software programs (e.g., stand-alone application, applet, mobile device application, etc.), according to an example embodiment of the invention. It will be appreciated that the interface can be formatted for display on a mobile device (e.g., personal communications device like a BlackBerry, iPhone, etc.) or non-mobile device (e.g., desktop computer, server computer, etc.), according to an example embodiment of the invention. The interface may be associated with security settings to enable access by certain registered users of the financial service provider system 105 and/or financial institution system 106. As desired, a private interface may be branded in accordance with specifications and/or preferences of a partner entity. Additionally, as desired in certain embodiments, the host modules 180 may be configured to provide a web services interface layer to another entity or component of the system 100.

The analytical processing modules 182 may include one or more suitable software modules that are operable, configured, and/or programmed to generate financial institution product offer proposals. As desired, the analytical processing modules 182 may evaluate a wide variety of historical information associated with a customer of a financial institution, such as account processing data associated with the financial institution and/or electronic bill presentment and payment data associated with the customer. In doing so, the analytical processing modules 182 may identify transaction information associated with payments directed to a second financial institution and/or bills received from the second financial institution. In this regard, one or more accounts of the customer with the second financial institution, such as loan accounts and/or credit card accounts, may be identified. The analytical processing modules 182 may additionally be configured to evaluate the transaction information and/or a wide variety of other information associated with the customer (e.g., customer indicators, etc.) in order to determine whether the customer is a candidate for one or more offer proposals associated with products of the financial institution. For example, the analytical processing modules 182 may determine whether the customer is a candidate for a loan offer proposal, credit card offer proposal, or other offer proposal associated with products of the financial institution.

In certain embodiments, the analytical processing modules 182 may be configured to invoke a wide variety of predictive models that evaluate customer data and/or transaction information. For example, the analytical processing modules 182 may be configured to invoke one or more predictive models that determine customer indicators. Additionally, the analytical processing modules 182 may be configured to utilize a wide variety of different rules in order to determine a customer candidacy for a product offer proposal and/or to customize a product offer proposal for the customer. Indeed, the analytical processing modules 182 may be configured to implement a wide variety of suitable processing methods and/or techniques as desired in various embodiments of the invention.

Additionally, the analytical processing modules 182 may be configured to receive data from the FI data database 172, the calculations and models database 173, the rules database 174, the data files 170, and/or from any number of external sources, such as the external databases 110a-n and/or the financial institution computers 140. The analytical processing modules 182 may additionally be configured to transmit or otherwise communicate information associated with generated offer proposals to a wide variety of different recipients, such as the financial institution computers 140. In certain embodiments, the analytical processing modules 182 may be configured to generate a product offer and facilitate the delivery of the generated product offer to a customer. As desired, a wide variety of different reporting functions may also be performed by the analytical processing modules 182.

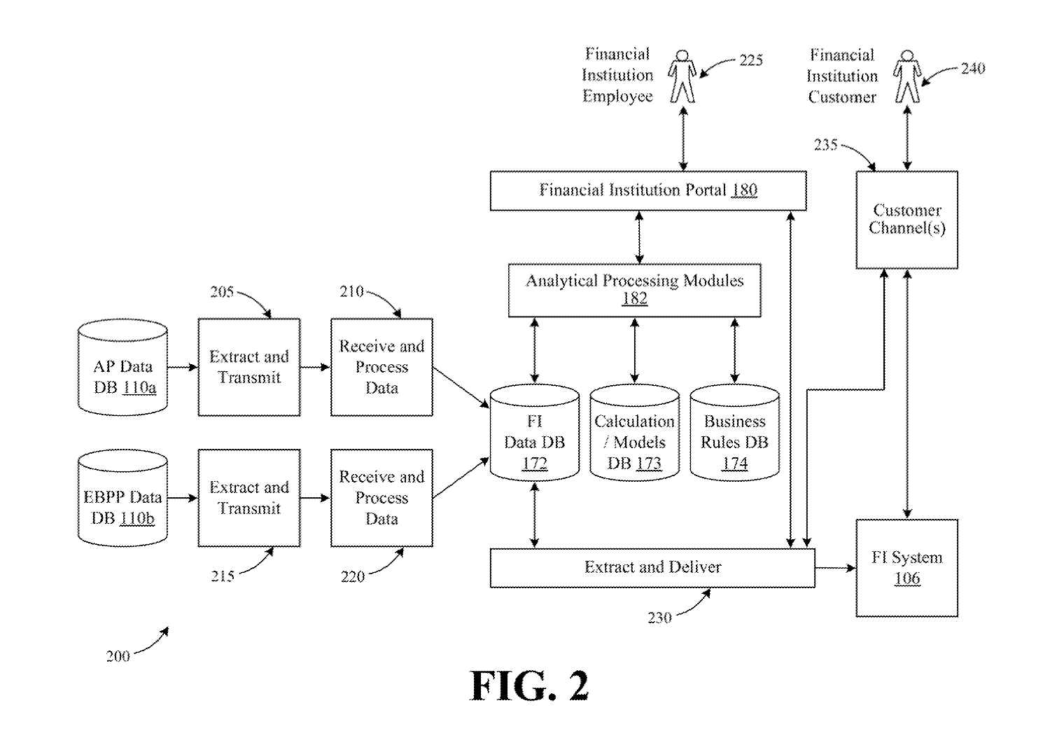

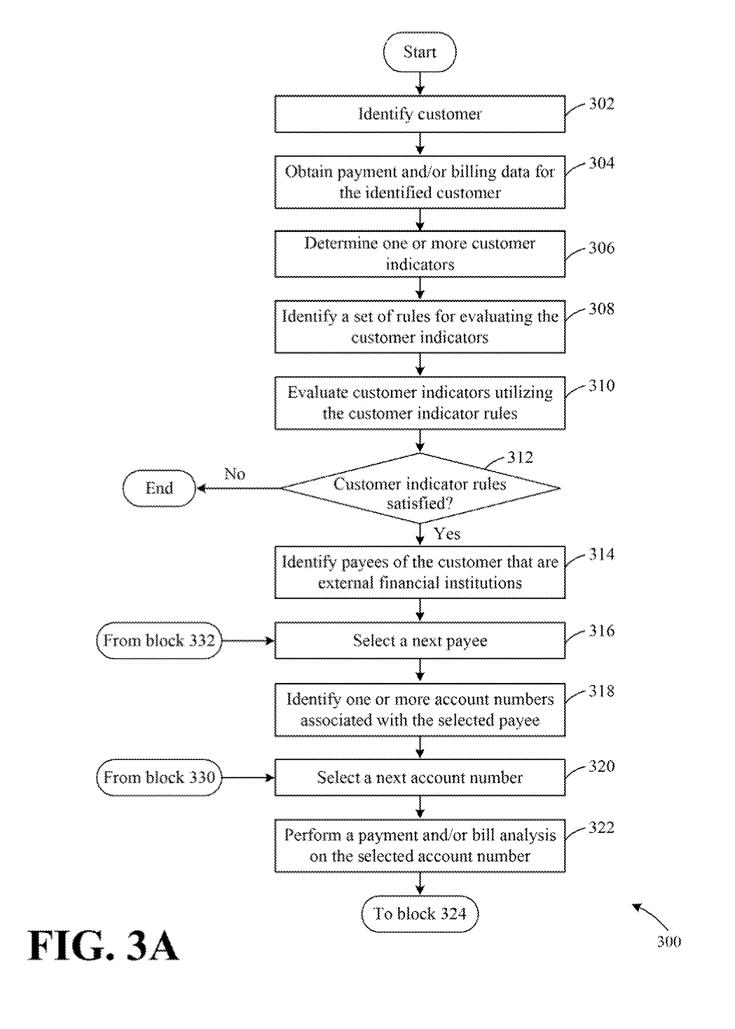

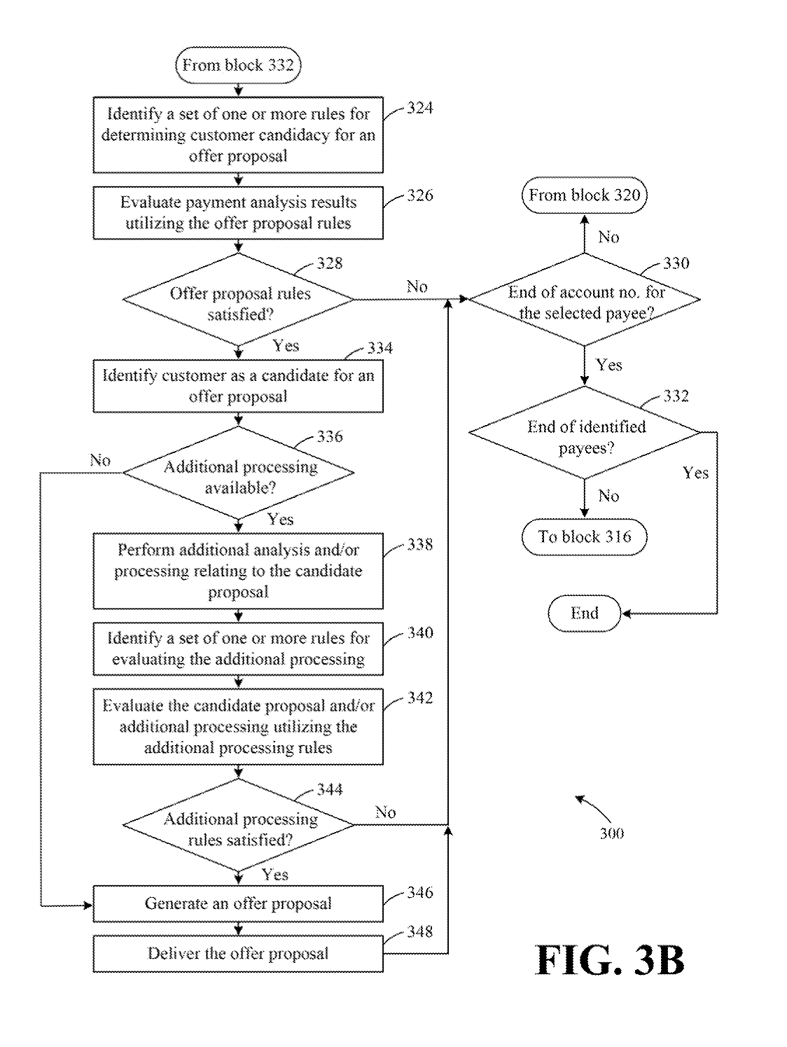

Additional details of the operations of the analytical processing modules 182 and/or the financial service provider system 105 operating logic and functionality are provided below with reference to FIGS. 2 and 3A-3B.

With continued reference to the financial service provider computer 160, the one or more I/O interfaces 166 may facilitate communication between the financial service provider computer 160 and one or more input/output devices; for example, one or more user interface devices, such as a display, a keypad, a mouse, a pointing device, a control panel, a touch screen display, a remote control, a microphone, a speaker, etc., that facilitate user interaction with the financial service provider computer 160. For example, a financial service provider employee may perform operational support and/or configure execution parameters utilizing one or more suitable input/output devices. The one or more network interfaces 168 may facilitate connection of the financial service provider computer 160 to one or more suitable networks, for example, the network(s) 144, 145 illustrated in FIG. 1, or local area network(s) within the financial service provider system 105. In this regard, the financial service provider computer 160 may receive and/or communicate information to other components of the system 100, such as the databases 110a-n (either directly or via one or more computers managing databases 110a-n), the financial institution systems 106, and/or the customer devices. As desired, any number of Web pages, interface screens, and/or other presentations (e.g., graphical user interfaces, etc.) may be provided or presented to a financial institution system 106 and/or financial institution computer 140 via the network 145.

The databases 110a-n can provide a wide variety of historical data and/or other information associated with customers of any number of financial institutions. In one example embodiment of the invention, the databases 110a-n may include one or more of an account processing (AP) data database, an electronic bill presentment and payment (EBPP) data database, and/or any number of databases 110n associated with other information. The AP data database 110a may include a wide variety of account information and/or transaction information associated with customers of a financial institution. For example, the AP data database 110a may include core account processing data associated with the financial institution. In certain embodiments, the AP data database 110a may be resident within a data center associated with the financial service provider. For example, in the event that the financial institution outsources account processing services to the service provider, the AP data database 110a may be maintained by the service provider. In other embodiments, the AP data database 110a may be maintained by the financial institution or by some other party.

A wide variety of information may be included in the AP data database 110a as desired in various embodiments of the invention, including but not limited to, payment and/or other transaction history information, for a predetermined period of time (e.g., six months, a year, etc.), that is associated with one or more demand deposit accounts for each customer of the financial institution and/or a wide variety of customer and/or customer account information that may be utilized in conjunction with various models, calculations and/or business rules, such as customer segment information, customer attrition risk information, customer loyalty information, etc. In certain embodiments, the AP data may include debit card payment data, check transaction data, automated check transaction data, and/or automated clearing house payment data, including recurring debit payments and/or payments performed through one or more bill payment and/or person-to-person payment services. Electronic transaction information (e.g., debit card payments, ACH payments, etc.) may include a wide variety of payment information, such as identification information for a payee, a payment amount, and/or a transaction date. However, in some situations, electronic transaction information may not include an account number of the customer with a payee. Check transaction information may include a payment amount and/or a payment date; however, check transaction information may not typically include identifying information (e.g., a name) for a payee. In certain embodiments, check transactions may have associated check images, and the check images may be processed in order to identify additional transaction information, such as payee identification information (e.g., a payee name included in a “pat to” field) and/or an account number of the customer with the payee (e.g., an account number included in a memo line or an account number included elsewhere on the check).

The EBPP data database 110b may include a wide variety of billing information associated with customers of the financial institution. In certain embodiments, the service provider may provide EBPP services on behalf of the financial institution to the customers of the financial institution. Accordingly, in certain embodiments, EBPP data may be maintained in a data center associated with the service provider. In other embodiments, the financial institution or another party may provide EBPP services, and the EBPP data may be located at another location. A wide variety of EBPP services may be provided to customers, such as electronic bill presentment services and/or electronic bill payment services (e.g., one time payments, recurring payments, etc.). Additionally, a wide variety of different types of data may be included in the EBPP data database 110b, including but not limited to, electronic billing information for a predetermined period of time, such as copies of electronic bills, bill summary information, and/or links (e.g., hyperlinks, etc.) to billing information stored by another entity (e.g., a biller or a biller service provider), as well as a wide variety of bill payment history information, such as payee identification information, remittance information, payment amount information, payment date information, and/or account information (e.g., account numbers) for customer accounts with payees.

In certain embodiments, electronic bill payment data may include additional data to that described above as being included in the AP data. For example, electronic bill payment data may include payee identification data, payment dates, payment amounts, and account numbers of customer accounts with payees. In certain embodiments, a customer of a bill payment service provider (e.g., a service provider that provides bill payment service to customers of the financial institution, a service provider that provides bill payment services independent of the financial institution, etc.) may have a personal payee list, and account numbers of the customer's payees may be associated with relevant entries in the personal payee list.

Although information not included in AP data may be obtained from electronic bill payment data, in certain embodiments, only a subset of a financial institution's customers may utilize electronic bill payment services. Additionally, even for customers that utilized electronic bill payment services, there may be certain bills of the customer that are not paid through the electronic bill payment services. For example, a customer may have a recurring debit established with a creditor, the customer may pay a bill with a debit card, and/or the customer may pay a bill with a paper or electronic check. Additionally, in the event that a customer has recently established electronic payment for a particular customer, a sufficient payment history may not be, available for analysis. Accordingly, it may be beneficial to evaluate electronic bill payment data (if available) in conjunction with electronic billing data and/or AP data for a customer.

In certain embodiments, electronic billing data may provide additional information not available from electronic bill payment data or AP data. For example, electronic billing data may provide indications for the timeliness of historical payments. In one example embodiment, due date information extracted from electronic billing data may be compared to bill payment data. In this regard, a determination may be made as to whether bills are paid by the customer in a timely manner. In certain embodiments, bill summary data may include due date information and amount due information (e.g., a minimum amount due, a total amount due, etc.). Additionally, in certain embodiments, bill detail data may include additional information. For example, with respect to a loan account, bill detail data may include information associated with an initial loan amount, a loan inception date, a remaining balance, an interest rate, and/or a loan term. As another example, with respect to a credit card account, bill detail data may include a maximum credit amount available. As desired, a wide variety of suitable mining agents and/or data processing techniques may be utilized to extract data from electronic billing information. For example, biller-specific mining agents and/or data extraction techniques may be utilized.

Much like the electronic bill payment services, only a subset of a financial institution's customers may utilize electronic bill presentment services. Additionally, even if electronic bills are available for a particular payee, a customer may have chosen not to activate electronic billing or electronic bill presentment for the payee. Accordingly, it may be beneficial to evaluate electronic billing data (if available) in conjunction with electronic bill payment data and/or AP data for a customer.

The other databases 110n may include a wide variety of other data that is accessible by the financial service provider system 105, such as transaction information associated with customers, information associated with other accounts (e.g., credit accounts, etc.) and/or products (e.g., loans, etc.) that the customers have with the financial institution, algorithms and/or models utilized to provide product offer proposal services, and/or various rules and/or preferences associated with financial institutions. As desired, one or more of the databases 110a-n may be maintained by a financial institution system 106. Alternatively, at least one of the databases 110a-n may be maintained by a third-party service provider or data source. Additionally, as desired, separate databases may be associated with different financial institutions. For example, the financial service provider system 105 may be configured to provide product offer proposal services for a plurality of different financial institutions, and a plurality of respective sources of information may be accessed in order to carry out these services.

Although not described or illustrated in detail, each financial institution computer 140 may be configured in the same or similar manner as described for the financial service provider system 105. For example, financial institution computer 140 may include one or more processor-based computers operable to store and execute computer-executable instructions, each having one or more processors, memories, I/O interfaces, network interfaces, operating systems, data files, databases or other data storage means, DBMS, host modules and other operating logic to perform some or all of the same or similar functions as are described herein with reference to the financial service provider system 105 (e.g., financial service provider computer 160).

Additionally, any number of customer devices 108 may be provided. Although not described or illustrated in detail, each customer device 108 may be a suitable processor-driven device, such as a personal computer or a mobile device, that facilitates the receipt of one or more product offers, such as product offers transmitted by the financial institution system 106 or product offers transmitted by the financial service provider system 105. As such, a customer device 108 may include any number of processors, memory devices, I/O interfaces, and/or network interfaces. The processors may access computer-executable instructions and/or programming modules (e.g., a Web browser) that facilitate operations of the customer device in accordance with various embodiments of the invention.

The networks 144, 145 may include any number of telecommunication and/or data networks, whether public, private, or a combination thereof, including but not limited to, the Internet, a local area network, a wide area network, an intranet, intermediate handheld data transfer devices, public switched telephone networks, and/or any combination thereof and may be wired and/or wireless. The networks 144, 145 may also allow for synchronous, including real-time, and/or asynchronous, including batch, transactions to be transmitted thereover. Due to network connectivity, various methodologies described herein may be practiced in the context of distributed computing environments. Although the system 100 is shown for simplicity as including networks 144, 145, it is to be understood that any other network configuration is possible, which may optionally include a plurality of networks for each of networks 144, 145, each with devices such as gateways and routers, for providing connectivity between or among networks.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. Accordingly, embodiments of the invention should not be construed as being limited to any particular operating environment, system architecture, or device configuration.

II. Operational Overview

A wide variety of suitable methods and/or techniques may be utilized as desired to evaluate customer information, generate a product offer proposal, transmit the generated product offer proposal, generate a product offer, and/or to deliver a generated product offer. FIG. 2 illustrates one example data flow 200 for generating and transmitting a financial institution product offer proposal and/or product offer, according to an illustrative embodiment of the invention. It will be appreciated that variations of the data flow 200 illustrated in FIG. 2 may be utilized in accordance with various embodiments of the invention.

With reference to FIG. 2, data associated with customers of a financial institution may be collected from a wide variety of different sources. For example, account processing (AP) data associated with the financial institution may be obtained. In certain embodiments, the AP data may be core AP data associated with transactions completed by and/or on behalf of the financial institution. Additionally, in certain embodiments, the AP data may be accessed from one or more AP data databases, such as the AP data databases 110a illustrated in FIG. 1. The AP data databases 110a may be maintained by a financial service provider (e.g., the financial institution outsources account processing to the service provider, etc.), maintained by the financial institution, and/or maintained by some other entity (e.g., the financial institution outsources account processing to another entity, etc.).

The AP data may include a wide variety of account processing information as desired in various embodiments of the invention. For example, the AP data may include transaction history information associated with one or more respective demand deposit accounts, including a primary demand deposit account, for each customer of the financial institution. In certain embodiments, transaction history information may be obtained for a predetermined historical period of time, such as the last six months, the last year, or some other period of time. As another example, the AP data may include a wide variety of additional customer and/or account information associated with one or more customers of the financial institution, such as data associated with fees (e.g., insufficient funds fees) incurred by the customers, data associated with interest income generated by the customers, and/or other account-related data. In certain embodiments, at least a portion of the additional data may be additional information that may be utilized in association with various models, calculations, and/or business rules in order to determine a customer candidacy for a product offer proposal. As desired, at least a portion of the additional data may include the results of one or more invoked models, calculations, and/or business rules.

Another example of data that may be obtained is electronic bill presentment and payment (EBPP) data. For example, EBPP data associated with customers of the financial institution may be obtained. In certain embodiments, the EBPP data may be data associated with bill presentment and/or payment services provided to the customers. In certain embodiments, the financial service provider may provide EBPP services on behalf of the financial institution to the customers of the financial institution. Alternatively, the service provider may independently provide EBPP services to customers of the financial institution that are also customers of the service provider. Accordingly, in certain embodiments, EBPP data may be maintained in a data center associated with the financial service provider. In other embodiments, the financial institution or another party may provide EBPP services, and the EBPP data may be located at another location. A wide variety of EBPP services may be provided to customers, such as electronic bill presentment services and/or electronic bill payment services (e.g., one time payments, recurring payments, etc.). In certain embodiments, the EBPP data may be accessed from one or more EBPP data databases, such as the EBPP data databases 110b illustrated in FIG. 1. As desired, The EBPP data databases 110b may be maintained by a financial service provider, the financial institution, and/or by some other entity. Additionally, as desired, the EBPP data may include data that is provided to various models, calculations, and/or business rules, as well as the results of one or more invoked models, calculations, and/or business rules.

The EBPP data may include a wide variety of billing information associated with customers of the financial institution. Examples of EBPP data include, but are not limited to, electronic billing information for a predetermined period of time, such as copies of electronic bills, bill summary information, and/or links (e.g., hyperlinks, etc.) to billing information stored by another entity (e.g., a biller or a biller service provider), as well as a wide variety of bill payment history information, such as payee identification information, remittance information, payment amount information, payment date information, and/or account information (e.g., account numbers) for customer accounts with payees.

Additionally, a wide variety of suitable techniques may be utilized to access data from the AP data databases 110a and/or the EBPP data databases 110b. For example, data may be accessed from a local database or obtained from an external database. In certain embodiments, data may extracted for use in a batch transmission process. For example, as shown at block 205, desired AP data may be identified and extracted from the AP data database. For example, desired data may be extracted based upon one or more parameters received from the financial service provider. As desired, the financial service provider may indicate or provide parameters associated with particular data that is desired, the frequency of extraction, and/or transmission, the scope of financial institution customers for which processing is to be performed, and/or any other desired extraction characteristics. Following extraction, one or more files of AP data may be transmitted to a suitable analytical processing data center, such as the financial service provider system 105 illustrated in FIG. 1. In certain embodiments, data may be periodically (e.g., once a day, once a week, once a month, etc.) extracted and transmitted. In other embodiments, data may be extracted and transmitted based upon the receipt of a request for the'data and/or based upon the occurrence of a predetermined event.

As desired, transmission processes other than batch transmission may be utilized. For example, AP data may be extracted and transmitted in a “just-in-time” manner based upon a request for the data (e.g., one or more suitable “pull” approaches, etc.) and/or based upon detected updates to a portion or all of the data (e.g., one or more suitable “push” approaches, etc.). In various embodiments, data may be encompassed in messages written to a message queue or one or more suitable Web services may be invoked to facilitate transmission of data. Other suitable transmission techniques will be appreciated. Additionally, transmitted data may include data for a single customer of the financial institution or data for a plurality of customers of the financial institution.

The AP data extracted from the AP data databases 110a may be received by the financial service provider system 105. The received data may be evaluated by the financial service provider system 105 and/or stored for subsequent evaluation. As shown at block 210, the AP data may be processed and loaded into one or more suitable data repositories. For example, the data may be normalized or otherwise processed prior to storage in one or more data repositories. In certain embodiments, the collected data may be stored in at least one database, such as a FI data or integrated data database configured to store both AP data and EBPP data, such as the FI data database 172 illustrated in FIG. 1. Prior to storage and/or integration with other stored data, a wide variety of suitable processing may be performed on the received data. For example, differences between data received from various data sources may be identified and removed. In certain embodiments, data may be normalized to facilitate analytical processing. In certain embodiments, processing may be performed on received batch data. In other embodiments, similar processing may be performed on data received via interprocess communications (e.g., message queuing, Web service calls, etc.).

EBPP data may be collected in a similar manner as that described above for the AP data. For example, at block 215, desired EBPP data may be identified and extracted from the EBPP data databases 110b. The extracted EBPP data may then be processed and transmitted to the financial service provider system 105. At block 220, the transmitted data may be received by the financial service provider system 105 and, as desired, further processed prior to analysis and/or storage in one or more suitable databases, such as the FI or integrated data databases 172. Accordingly, in certain embodiments, an integrated repository of account and billing data may be maintained for analytical processing. Thus, in certain embodiments, relatively efficient analysis of data may be performed without impacting the operational performance of the account processing and/or the EBPP functionality.

Once data has been collected for processing, a wide variety of analytical processing may be performed on the data. For example, one or more modules that include analytical processing modules 182 may access data from the FI or integrated data databases 172, and the analytical processing modules 182 may evaluate at least a portion of the accessed data in order to determine whether a customer of the financial institution is a candidate for a financial product offer proposal. In doing so, the analytical processing modules 182 may conduct a wide variety of different analyses and/or evaluations. In certain embodiments, these analyses and/or evaluations may utilize a wide variety of different predictive models and/or rules, such as predictive models obtained from a calculations and models database 173 and/or rules obtained from a business rules database 174.

In certain embodiments, various rules and/or parameters for determining whether a customer is a candidate for a financial product offer proposal may be received from one or more financial institution computers and/or financial institution devices, such as the financial institution computers 140 illustrated in FIG. 1. For example, a financial institution computer 140 may provide evaluation and/or analytical rules to the financial service provider system 105 for storage in the business rules database 174 and/or for use by the analytical processing modules 182. As another example, a financial institution employee 225 may utilize a financial institution computer 140 (e.g., a workstation, a mobile device, etc.) to access a financial institution portal 180 (e.g., a portal provided by one or more suitable host modules), such as a portal that provides one or more Web user interfaces to the financial institution employee 225. In this regard, the financial institution employee 225 may provide a wide variety of different preferences and/or data to the financial service provider system 105 for use by the analytical processing modules 182. For example, a financial institution employee 225 may provide information associated with, but not limited to, the selection and/or definition of business rules to be utilized by the analytical processing modules 182, the configuration of the execution of the analytical processing modules 182 (e.g., information associated with the scope of financial institution customers to be evaluated, the frequency of evaluation, a schedule for execution, etc.), the triggering of an analytical process (e.g., a request to evaluate a particular customer or group of customers, etc.), the review, modification, approval, and/or further analysis of the results of one or more analytical processes (e.g., the review of product offer proposals, the modification of product offer proposals, the customization of product offer proposals, the further evaluation of product offer proposals, etc.), and/or the releasing or transmission of product offer proposals and/or product offers to other components of the financial institution system 106 and/or to customers of the financial institution.

As desired, the financial institution portal 180 may interact directly with the analytical processing modules 182 and/or with any number of the databases, such as the business rules database 174. In this regard, the financial institution employee 225 may create, review, modify, and/or update information stored in the databases, such as business rules utilized by the analytical processing modules 182. Additionally, the financial institution employee 225 may request evaluation of a customer, and the financial institution employee 225 may review and/or modify results of the evaluation, such as a product offer proposal for the customer.

As mentioned above, a wide variety of different evaluations and/or analyses may be performed on the integrated data by the analytical processing modules 182. For example, an analytical process may be performed to determine whether one or more customers of the financial institution are candidates for various product offer proposals and/or various product offers. Other analytical processing may be performed to proactively identify product pricing for optimal customer retention and/or financial institution profitability. In certain embodiments, the results of an analytical process (e.g., a product offer proposal, product pricing information, etc.) may be stored in the FI or integrated data database 172. For example, results may be stored in association with a relevant financial institution customer and/or in a file or interprocess communication mechanism (e.g., a message queue, etc.) for subsequent transmission to a financial institution computer 140 and/or the customer. In other embodiments, results may be communicated without storing the results in a suitable database or other data repository.

Assuming that results (e.g., product offer proposals, etc.) are stored in a suitable database, the results may be extracted and delivered utilizing a wide variety of suitable methods and/or techniques. With reference to FIG. 2, an extract and deliver block 230 may be utilized to extract results from the database and deliver at least a portion of the extracted results to a recipient. Examples of suitable methods for delivering results include, but are not limited to, formatting results for display to the financial institution employee 225 via the financial institution portal 180, transmitting results to the financial institution system 106 or any number of financial institution computers 140 (e.g., a computer other than a computer associated with the financial institution employee 225, etc.), formatting results for display to a customer of the financial institution (e.g., formatting an offer proposal for display to the customer, etc.), and/or transmitting or otherwise delivering results to the customer.

In certain embodiments, a financial offer proposal may be communicated to the financial institution system 106 and/or to a financial institution computer 140 (e.g., a computer associated with the financial institution employee 225, a marketing campaign management computer associated with the financial institution, etc.). In this regard, the results may be further evaluated by any number of financial institution employees and/or financial institution systems. As desired, the financial institution may then deliver a product offer based upon a product offer proposal to the customer. In other embodiments, a product offer may be delivered to the customer by the financial service provider, either automatically based upon a determination that financial institution parameters have been satisfied or following the receipt of an approval of a product offer proposal from a financial institution computer 140.

Regardless of the entity that communicates a product offer to a customer, a wide variety of suitable customer channels 235 may be utilized as desired to present, deliver, and/or transmit a product offer to a recipient customer 240 (e.g., a consumer, a small business, etc.). These customer channels 235 may include unidirectional and/or bidirectional customer channels. Examples of suitable customer channels include, but are not limited to, a financial institution employee (e.g., a bank teller, a customer service representative, etc.) delivering a product offer to the customer 240 at a financial institution location, a telephone call made to a telephone number of the customer 240, an automated teller machine (ATM) customer channel that presents a product offer during an ATM interaction, “snail” mail of a product offer, email of a product offer to an email account of the customer 240, short message service (SMS) messaging of a product offer to a telephone number of the customer 240, and/or an online banking interface (e.g., a consumer online banking user interface, a small business online banking user interface, etc.) interaction with the customer 240 that may optionally provide for “in application” messaging. In certain embodiments, a wide variety of suitable customer preferences and/or customer criteria may be evaluated in order to determine or identify a suitable customer channel 235.

As set forth above, a wide variety of suitable techniques may be utilized to evaluate customer information in order to determine customer eligibility or candidacy for product offer proposals. FIGS. 3A and 3B illustrate a flow diagram of an example method 300 for evaluating transaction information in order to selectively generate financial institution product offer proposals, according to an illustrative embodiment of the invention. Although the method 300 is described in conjunction with a single customer of a financial institution, similar operations may be performed to evaluate other customers of the financial institution or other financial institutions. In certain embodiments, the method 300 may be performed by a suitable financial service provider system and/or associated financial service provider computers, such as the financial service provider system 105 and/or financial service provider computers 160 illustrated in FIG. 1. The method 300 may begin at block 302.

At block 302, a customer may be identified for evaluation or analysis. In certain embodiments of the invention, the customer may be identified based upon the receipt of a request to evaluate the customer, such as a request received from a financial institution employee or a request included in a batch file transmission. For example, a suitable financial institution computer, such as the financial institution computer 140 illustrated in FIG. 1, may provide information associated with one or more customers, and the customer may be identified based upon an analysis of the received information. For example, received customer identification information (e.g., customer name, etc.) may be utilized to identify the customer. As another example, received account identification information (e.g., an account number, etc.) may be evaluated, and a customer associated with the account may be identified. As desired, the method 300 of FIG. 3 may be implemented on behalf of a single customer or implemented in an iterative or looping manner on behalf of a plurality of customers.

At block 304, historical information may be obtained for the identified customer. For example, historical information may be accessed from local databases or data repositories, such as the FI data databases 172 illustrated in FIG. 1, and/or collected from external databases or data repositories, such as the AP data databases 110a and/or the EBPP data databases 110b illustrated in FIG. 1. The historical information may include a wide variety of information associated with the customer, such as account processing data associated with one or more deposit accounts of the customer with the financial institution, electronic bill payment data for the customer, and/or electronic bill presentment or electronic billing data for the customer.

At block 306, one or more indicators, factors, and/or values (collectively referred to as customer indicators) associated with the identified customer may be calculated, determined, and/or otherwise identified. In certain embodiments, the one or more customer indicators may permit an evaluation of the customer in order to determine whether the customer is eligible for a product offer proposal analysis. A wide variety of different types of customer indicators may be utilized as desired in various embodiments of the invention. Examples of suitable customer indicators include, but are not limited to, a customer segment, an attrition risk or attrition propensity, a customer loyalty, a customer value, an indicator of a next best offer to make to the customer, a customer candidacy for a loan, and/or a customer share of a wallet (e.g., a percentage of the customer's business with the financial institution, etc.). In certain embodiments, at least a portion of the historical information may be evaluated or analyzed in order to determine one or more of the customer indicators. For example, one or more predictive models and/or analytical techniques may be utilized to derive customer indicators from at least a portion of the AP data. As another example, received and/or previously stored customer indicators may be identified.

In certain embodiments, a customer segment may be a customer classification associated with a value of the customer to the financial institution. A wide variety of different customer segments and/or types of customer segments may be utilized as desired in various embodiments of the invention. These various customer segments may take a wide variety of different factors and/or considerations into account, such as the respective incomes generated by the customers for the financial institution. In certain embodiments, both interest income and non-interest income (e.g., fees, etc.) for a customer may be considered when determining a customer segment. In one example embodiment, interest and/or non-interest income may be extracted or derived from historical AP data and may be provided to one or more calculations and/or predictive models, potentially with other customer data, in order to determine an appropriate customer segment. In other embodiments, other determinations and/or evaluations may be utilized to determine a customer segment.

An attrition risk or attrition propensity may represent a likelihood that a customer will cancel a relationship (e.g., an account relationship, etc.) with the financial institution and move business to another financial institution. In certain embodiments, one or more predictive models may be invoked and/or utilized in order to evaluate historical information to determine an attrition risk for the customer. The attrition risk may be expressed, for example, as a probability or a score within a defined range. The one or more predictive models utilized to evaluate the customer may be identified and/or selected based at least in part upon a wide variety of different factors, such as one or more customer attributes. As one example, a predictive model may be identified based upon a tenure of the customer with the financial institution. Additionally, a wide variety of different types of predictive models may be utilized, such as logistic regression models, neural network models, and/or other types of models.

As desired, other customer indicators may be determined utilizing similar techniques as those set forth above, as well as other techniques that will be readily appreciated. Additionally, any of the customer indicators may be received from the financial institution. A customer loyalty may represent a loyalty of the customer to the financial institution and, similar to the attrition risk, may optionally be expressed as a score or a probability within a defined range. For example, the customer loyalty may represent a relatively long-term loyalty while an attrition risk may represent a relatively short-term attrition propensity. A customer value may represent a value of the customer to the financial institution, and may take income derived from the customer into consideration. As desired, a customer value may be expressed as a score or a probability within a defined range, thereby providing a customer-specific value that may be more specific than a customer segmentation. Additionally, a wide variety of suitable methods and/or techniques may be utilized as desired to determine a customer value. A few example techniques are described in U.S. patent application Ser. No. 12/893,822, filed Sep. 29, 2010 and entitled “Systems and Methods for Customer Value Optimization Involving Product/Service Optimization,” and in U.S. patent application Ser. No. 12/893,841, filed Sep. 29, 2010 and entitled “Systems and Methods for Customer Value Optimization Involving Relationship Optimization.” Each of these applications is incorporated by reference herein it its entirety.

A next best offer may represent a product offer or product offer type that the financial institution would like to offer to the customer and/or that the customer may be likely to accept. A few examples of methods and/or techniques that may be utilized to identify an optimized next best offer are described in the two incorporated patent applications. A customer candidacy for a loan may represent whether the customer is a likely candidate for a loan given a set of criteria. A share of the wallet may represent a percentage of the customer's business and/or financial institution payments that are being made to the financial institution. For example, if a customer has a first loan account with the financial institution and a second loan account with a second financial institution, the share of the wallet may represent the percentage of total loan payments being made to the financial institution.

Following the determination or identification of customer indicators at block 306, operations may continue at block 308. At block 308, a set of one or more rules (e.g., business rules, etc.) for evaluating the customer indicators may be identified. For example, rules may be accessed from a suitable rules database, such as the rules database 174 illustrated in FIG. 1. As another example, rules may be received from a suitable financial institution computer; such as a financial institution computer utilized by a financial institution employee. A wide variety of different types of customer indicator rules may be included in the set of rules, including default business rules and/or business rules (e.g., customized business rules) specified by the financial institution or a financial institution employee. Examples of suitable rules include, but are not limited to, rules that evaluate a share of the wallet, rules that evaluate a customer value, rules that evaluate loan candidacy, and/or rules that evaluate any number of other customer indicators. As desired, a rule may facilitate and/or direct comparison of one or more customer indicator values to any number of suitable threshold values and/or predetermined conditions. Alternatively, a rule may specify the evaluation of one or more customer indicators utilizing one or more suitable formulas or evaluation techniques. As desired, a rule may also specify or indicate one or more actions to take based upon the results of an evaluation or analysis (e.g., a determination that one or more conditions are satisfied, etc.). In certain embodiments, a plurality of rules may be applicable to the evaluation of the customer indicators, and a suitable hierarchy of rules may be established and utilized to select applicable customer indicator rules and/or an order for implementing customer indicator rules.

At block 310, one or more of the customer indicators may be evaluated utilizing the set of one or more customer indicator rules. For example, various customer indicator values may be compared to any number of thresholds and/or ranges associated with the customer indicator rules. At block 312, a determination may be made based at least in part upon the evaluation as to whether the set of customer indicator rules has been satisfied. For example, a determination may be made as to whether a customer value exceeds a low value threshold. As another example, a determination may be made as to whether the customer is a candidate for a loan. As yet another example, a determination may be made as to whether the share of the wallet satisfies one or more wallet share thresholds. Other determinations may be made as desired at block 312 based upon an evaluation of the customer indicator rules. If it is determined at block 312 that the customer indicator rules have not been satisfied, then operations may end. In other words, a determination may be made that further evaluation of the customer will not be performed. If, however, it is determined at block 312 that the customer indicator rules have been satisfied, then operations may continue at block 314.

At block 314, payees of the customer that are external financial institutions may be identified. In certain embodiments, historical information associated with the customer may be evaluated and/or analyzed in order to determine payees of the customer. Payees that are other financial institutions (i.e., financial institutions other than a financial institution on whose behalf the analysis is performed) may then be identified from the payees. A wide variety of historical information may be evaluated as desired at block 314, including but not limited to, AP data and/or electronic billing data (e.g., electronic bill payment data, electronic bill presentment data, etc.). Additionally, a wide variety of suitable methods and/or techniques may be utilized as desired to identify financial institution payees. For example, electronic billing data and/or electronic transaction data may be parsed in order to identify designated payees, and a determination may be made as to whether the payees are financial institution payees. As another example, an intelligent character recognition (ICR) process and/or an optical character recognition (OCR) process may be performed on electronic check images (e.g., performed on payee fields within electronic check images, etc.) in order to identify designated payees, and a determination may be made as to whether the payees are financial institution payees.

As desired in various embodiments, a wide variety of suitable techniques may be utilized to determine whether a designated payee is a financial institution payee. Certain payees, such as managed bill payment payees (e.g., bill payment payees having an established remittance relationship with an EBPP service provider, etc.) and/or certain electronic billers, may be readily identified as financial institution payees based at least in part upon stored information associated with the payees. With respect to other payees, such as unmanaged payees and/or payees identified from AP data, an analysis of how the customer has identified each payee may be performed in order to determine whether the payee is a financial institution payee. For example, customer payee designations (e.g., payee names, etc.) may be identified utilizing any number of suitable data mining techniques (e.g., parsing, optical character recognition, etc.), and the payee designations may be evaluated in order to determine whether the payees are financial institution payees. Additionally, any references to the current financial institution may be eliminated.

A wide variety of analytical and/or evaluation techniques may be utilized to evaluate payee designations. In certain embodiments, a multi-pass processing technique may be utilized to evaluate the payee designations. For example, payee designations may be searched to identify predetermined terms or text strings, such as “bank” or “credit union,” and a payee may be identified as a financial institution payee based at least in part upon the identification. As another example, payee designations may be compared to a stored list of known financial institutions (including loan providers, regional financial institutions relevant to the customer, etc.), and payees may be identified as financial institution payees based at least in part upon the comparisons. Additionally, as desired, various rules may be applied to payee designations that produce relatively ambiguous results in order to determine whether the payee designations are for financial institution payees. For example, given a payee designation of State Farm, various rules may be utilized to determine whether the payee designation refers to the insurance company or the bank. Example rules may evaluate a remittance center address, an account number, a payment amount, and/or a payment frequency in order to determine whether a designated payee is a financial institution payee.

Following the identification of external financial institution payees at block 314, operations may continue at block 316. At block 316, a next financial institution payee may be selected for evaluation. In this regard, each financial institution payee may be evaluated and any generated product offer proposals may be associated with particular financial institution payees (and accounts with the financial institution payees). Following the selection of a financial institution payee, operations may continue at block 318, and one or more account numbers associated with the selected financial institution payee may be identified or determined. For example, a set of transaction data for the financial institution may be identified, including payment data and/or billing data associated with the financial institution. It cannot be assumed that all payments to the selected financial institution payee and/or bills from the financial institution payee are for a single account (e.g., a loan account, a credit card account, etc.). Accordingly, one or more distinct account numbers associated with the transaction data for the selected financial institution payee may be identified or determined.

A wide variety of suitable techniques may be utilized to identify or determine distinct account numbers. For example, in the event that the customer has established the financial institution payee in a personal payee list for bill payment functionality, the personal payee list may be evaluated in order to identify distinct account number. As another example, electronic bill payment data may be evaluated in order to determine account numbers. As yet another example, electronic billing data, such as bill detail data, may be evaluated in order to determine account numbers. As yet another example, check images may be processed in order to identify account numbers. For certain types of transactions, it may be difficult to identify account numbers. Accordingly, in certain embodiments, a temporary or “fake” account number may be identified and/or generated to analyze payments for which specific account numbers cannot be identified.

At block 320, a next account number may be selected for evaluation. In this regard, each account number (including the “fake” account number) associated with the selected financial institution payee may be evaluated, and any generated product offer proposals (or product offers) may be generated in relation to a particular financial institution account. Following the selection of an account number, operations may continue at block 322. At block 322, a payment and/or bill analysis may be performed for the selected account number. In certain embodiments, the analysis may determine whether a pattern of recurring payments is associated with the selected account number.

In various embodiments, a wide variety of suitable operations may be performed in a payment and/or bill analysis. For example, all transactions associated with the selected account number may be identified, including transactions identified from AP data, electronic bill payment data, and/or electronic billing data. The transaction data may then be evaluated in an attempt to identify at least a payment periodicity. For example, a history of payments may be evaluated in order to determine whether a recurring payment pattern (e.g., monthly payments, etc.) exists. Additionally, the payment data may be evaluated in order to determine a wide variety of other information associated with the payments. For example, a payment history may be evaluated in order to determine a number of payments that have been made in association with the selected account number. As desired, payments spanning across multiple payment methods may be evaluated in order to determine a number of payments that have been made. In this regard, if the payment method has been changed by the customer (e.g., changed from check payment to electronic payment), a number of payments may still be identified.

As another example of additional information, a fixed payment amount may be identified or determined. For example, a monthly fixed payment amount may be determined. Because customers are typically allowed to override or set a payment amount (e.g., a loan payment, etc.), an amount of a recurring payment may not be an amount owed for each payment. Accordingly, in certain embodiments, both billing information and payment information may be evaluated in order to determine a payment amount. Additionally, in the event that a fixed payment amount cannot be determined, a mean payment amount and/or a variance for the payment amounts may be determined.

As yet another example of additional information, a timeliness of customer payments may be determined. For example, if electronic billing information is available, a comparison of payment dates associated with electronic payments to the due dates of the bills may be performed in order to identify or determine a timeliness of payments. As yet another example of additional information, details associated with a loan account or a credit account may be identified. For example, bill detail data may be evaluated to identify one or more of an initial loan amount, a loan inception date, a remaining loan balance, a loan interest rate, a loan term, a credit card interest rate, and/or a maximum credit limit associated with a credit account. Indeed, a wide variety of information associated with the selected payment account number may be identified or determined as desired in various embodiments of the invention.

Once a payment and/or billing analysis has been completed, a wide variety of characteristics associated with the external financial institution account or relationship may be identified. As desired, loan payment accounts may be differentiated from credit card payment accounts. For example, differences between fixed and variable payment amounts may be identified to distinguish the two types of accounts. As desired, loan payment accounts may further be differentiated as to a type of loan (e.g., an automobile loan, a mortgage, etc.) based upon a wide variety of different characteristics, such as a payment amount. For example, an automobile loan typically involves a lower payment amount and a shorter term than a mortgage loan. As one illustrative example, a loan account having a monthly payment amount of less than approximately $1000 may be identified as an automobile or personal loan account. A loan account having a monthly payment amount of greater than $1000 and/or a payment history greater than a predetermined threshold (e.g., five years, seven years, etc.) may be identified as a mortgage loan account.

At block 324, a set of one or more rules (e.g., business rules, etc.) for evaluating the payment and/or billing analysis results may be identified. For example, rules may be accessed from a suitable rules database 174. As another example, rules may be received from a suitable financial institution computer, such as a financial institution computer utilized by a financial institution employee. In certain embodiments, the rules may be rules associated with determining whether the customer qualifies for a product offer proposal (or product offer). For example, the rules may be utilized to determine whether a product offer proposal that competes with or that complements the analyzed customer account should be generated or whether the customer account should be eliminated from further consideration. A wide variety of different types of offer proposal rules may be included in the set of rules, including default business rules and/or business rules (e.g., customized business rules) specified by the financial institution or a financial institution employee. Examples of suitable rules include, but are not limited to, rules that establish conditions for eliminating accounts from further consideration for a product offer proposal (e.g., a rule to eliminate automobile/personal loans with less than one year of prior payment, a rule to eliminate loan accounts with a relatively short remaining term, a rule to eliminate loan accounts that exceed monetary thresholds, etc.) and/or rules that establish conditions for identifying an offer proposal opportunity (e.g., a rule to identify an opportunity for a loan having a prior payment history satisfying a predetermined timing threshold (e.g., at least 24 months, at least 30 months, etc.) and limited or no late payments). As desired, a rule may facilitate and/or direct comparison of one or more payment and/or billing analysis values to any number of suitable threshold values and/or predetermined conditions. Alternatively, a rule may specify the evaluation of one or more values utilizing one or more suitable formulas or evaluation techniques. As desired, a rule may also specify or indicate one or more actions to take based upon the results of an evaluation or analysis (e.g., a determination that one or more conditions are satisfied, etc.). In certain embodiments, a plurality of rules may be applicable to the evaluation of payment and/or billing analysis results, and a suitable hierarchy of rules may be established and utilized to select applicable rules and/or an order for implementing rules. Additionally, in certain embodiments, the set of rules may be selected based upon a wide variety of different information, such as customer demographic information and/or geographical location information. For example, mortgage loan account rules utilized in an area having relatively high property values may be different from rules utilized in an area having relatively low property values.

At block 326, the results of the payment history and/or billing analysis may be evaluated utilizing the set of one or more offer proposal rules. For example, various parameters associated with the selected account may be input as variables into one or more applicable rules in order to execute and/or evaluate the rules. At block 328, a determination may be made based at least in part upon the evaluation as to whether the set of rules have been satisfied. For example, a determination may be made as to whether one or more proposed product offer conditions or offer proposal rules (e.g., payment history conditions, remaining loan term conditions, payment amount conditions, loan type conditions, etc.) are satisfied by the parameters associated with the selected account. If it is determined at block 328 that the set of offer proposal rules has not been satisfied, then operations may continue at block 330. At block 330, a determination may be made as to whether the end of the account numbers associated with the selected financial institution payee has been reached. If it is determined at block 330 that the end of the account numbers has not been reached, then operations may continue at block 320, and a next account number may be selected for evaluation. If, however, it is determined at block 330 that the end of the account numbers has been reached, then operations may continue at block 332. At block 332, a determination may be made as to whether the end of the financial institution payees has been reached. If it is determined at block 332 that the end of the financial institution payees has not been reached, then operations may continue at block 316, and a next financial institution payee may be selected for evaluation. If, however, it is determined at block 332 that the end of the financial institution payees has been reached, then operations may end.

If, however, it is determined at block 328 that the one or more proposed offer rules or conditions have been satisfied, then operations may continue at block 334. At block 334, the customer may be identified as a candidate for a product offer proposal (or product offer) in the context of processing the selected account. For example, a competing or complementing product offer proposal (e.g., a competing loan offer proposal, a competing credit card offer proposal, etc.) may be generated in relation to the selected account. In this regard, information associated with a proposed product offer proposal may be generated for provision to a financial institution and/or a financial institution employee. Subsequent, the product offer proposal may be processes to generate a product offer, and the product offer may be delivered to the customer by the financial institution. In other embodiments, a product offer may be generated and delivered to the customer by the financial service provider.

At block 336, following the identification of the account as a candidate for an offer proposal in the context of the selected account, a determination may be made as to whether one or more additional processing techniques are available for evaluating the product offer candidacy. A wide variety of additional processing techniques may be utilized as desired in various embodiments of the invention in order to identify conditions that may eliminate the candidacy of the customer for a product offer proposal in the context of the current account and/or to modify various terms associated with a product offer proposal. In certain embodiments, the utilization of additional processing techniques may be based at least in part upon preferences associated with the primary financial institution of the customer (e.g., the financial institution on whose behalf the analysis is being performed). Examples of additional processing techniques include, but are not limited to, the calculation of an average monthly gap between inflow and outflow associated with a primary demand deposit account of the customer, the identification of a nature of a lender, and/or the identification of a total number of loan and/or credit card payments associated with the customer.

An average monthly gap calculation may determine amounts for the total debits and/or total credits associated with the primary deposit account of the customer with the financial institution. For example, the total debits and/or total credits may be determined for a predetermined period of time, and an average monthly gap between the total debits and total credits may then be calculated. In certain embodiments, the gap analysis may additionally or alternatively identify and encompass transfers to and/or from other accounts, such as savings accounts and/or investment accounts in a similar manner. As desired, an identified average monthly gas surplus may be added to a payment amount associated with a current or selected account relationship in order to determine an upper limit on a monthly payment amount. Similarly, an identified average monthly gap deficiency may be subtracted from a payment amount associated with the selected account relationship in order to determine an upper limit on a monthly payment amount. In certain embodiments, the lowering of a monthly payment amount limit may result in the elimination of the product offer proposal.

An identification of the nature of a lender may be utilized to identify certain types of account relationships which may rigger the elimination of the offer proposal. For example, a payee name for the lender may be utilized to identify a type associated with the lender. Certain lenders may be associated with subprime loans and/or indirect relationships with customers, such as a loan obtained through auto financing at a car dealership. Once a type associated with the lender has been identified, certain product offer proposals may be eliminated based upon the identified type. For example, a product offer proposal for a loan may be eliminated if a current loan is identified as a subprime loan.

A total number of loan and/or credit card payments associated with the customer may be determined utilizing a wide variety of suitable techniques. For example, a total number of loan and/or credit card payments to the current financial institution associated with the primary demand deposit account of the customer and/or to any number of other financial institutions may be identified. The total number of loan and/or credit card payments may then be utilized to derive or calculate a total monthly payment obligation (e.g., a fixed amount, a mean amount, etc.) for the customer, which may be associated with a monthly income figure associated with the customer. The derived payment obligation, optionally relative to income, may then be evaluated in order to determine whether the product offer proposal will be eliminated.

If it is determined at block 336 that additional processing is not available, then operations may continue at block 346 described in greater detail below. If, however, it is determined at block 336 that additional processing is available, then operations may continue at block 338. At block 338, additional processing and/or additional analysis relating to the product offer proposal, such as the additional processing described above with reference to block 336, may be performed. For example, an average monthly gap analysis, a lender nature analysis, and/or an obligation relative to income analysis may be performed. As desired, other additional processing and/or analyses may additionally or alternatively be performed.

At block 340, a set of one or more rules (e.g., business rules, etc.) for evaluating the results of the additional processing may be identified. For example, rules may be accessed from a suitable rules database 174. As another example, rules may be received from a suitable financial institution computer, such as a financial institution computer utilized by a financial institution employee. In certain embodiments, the rules may be rules associated with determining whether the product offer proposal should be eliminated or pursued. A wide variety of different types of additional processing rules may be included in the set of rules, including default business rules and/or business rules (e.g., customized business rules) specified by the financial institution or a financial institution employee. Examples of suitable additional processing rules include, but are not limited to, rules that leverage the analyses or calculations performed in block 338. These may, for example, eliminate or modify a product offer proposal as a function of certain threshold conditions based on calculating an average monthly gap, identify a type associated with a lender, and/or determining a total monthly credit and/or loan payments obligation. In certain embodiments, a plurality of rules may be applicable to the evaluation of additional payment analysis results, and a suitable hierarchy of rules may be established and utilized to select applicable rules and/or an order for implementing rules.

At block 342, the set of one or more additional processing rules identified at block 340 may be evaluated utilizing the results of the additionally analysis and/or processing performed at block 338. At block 344, a determination may be made based at least in part upon the evaluation as to whether the set of additional processing rules has been satisfied. If it is determined at block 344 that the set of additional processing rules has not been satisfied, then operations may continue at block 330 described above. If, however, it is determined at block 344 that the set of additional processing rules has been satisfied, then operations may continue at block 346.

At block 346, a product offer proposal may be generated in association with the selected account number or selected account relationship. A product offer proposal may include a wide variety of terms and/or criteria associated with a proposed product offering, including but not limited to, a type of product (e.g., an automobile loan, a mortgage loan, a credit card, etc.), an amount (e.g., a proposed loan amount, etc.), a term (e.g., a loan term, etc.), a maximum credit limit (e.g., a maximum limit for a credit card, etc.), and/or an interest rate (e.g., a loan interest rate, a credit card interest rate, an introductory credit card interest rate, etc.).

Additionally, in certain embodiments, the product offer proposal may be customized or tailored for a customer and/or a financial institution based upon the evaluation of the customer and/or the customer account and/or based upon any number of preferences and/or criteria associated with the financial institution. Additionally, or alternatively, the previous execution of one or more business rules may result in the customization of a product offer proposal. As an example of customization, one or more proposed terms for a product offer proposal may be based at least in part upon the evaluation of one or more rules at block 326 and/or at block 342. As one example, the determination of a current monthly payment amount for the customer may be utilized in conjunction with information regarding a total monthly payment obligation and/or an assumed term and interest rate to determine a maximum loan amount for a loan product offer proposal. As another example, an identification of a subprime creditor or a relatively large set of customer payment obligations may result in the association of a relatively higher interest rate with a product offer proposal in order to offset increased risk. As yet another example, the identification of a relatively high income customer segment, a relatively high customer value, and/or a relatively high customer loyalty may result in the proposal of preferential product offer terms for the customer.

At block 348, the product offer proposal may be delivered to the financial institution for review, further processing, and/or delivery to the customer. For example, the product offer proposal may be transmitted to a financial institution computer associated with a financial institution employee via a suitable financial institution portal. In this regard, the financial institution employee may review the product offer proposal. As another example, the product offer proposal may be transmitted to another financial institution computer for analysis, further modification, inclusion in a marketing campaign, and/or delivery to the customer. As desired, a financial institution computer and/or a financial institution employee may facilitate the review of a received product offer proposal and/or a wide variety of additional processing on the product offer proposal. Any number of terms or conditions included in the product offer proposal may be modified, and any modification may optionally be returned to the financial institution service provider system 105.

In the event that a product offer proposal is accepted, a product offer may be generated based at least in part upon the product offer proposal, and the generated product offer may be delivered to the customer via any number of suitable communication channels. In certain embodiments, a financial institution system and/or financial institution personnel may generate the product offer. In other embodiments, the financial service provider system 105 may generate the product offer. For example, the financial service provider system 105 may generate the product offer following the receipt of a product offer proposal acceptance from the financial institution. As another example, the financial service provider system 105 may generate the product offer without first receiving financial institution approval (e.g., an automatic product offer generation, an offer generation based upon a determination that one or more predetermined conditions are satisfied by the product offer proposal and/or the customer, etc.).

In certain embodiments, a wide variety of additional types of processing and/or analysis may be performed prior to the generation of a product offer. For example, a credit check and/or other credit analysis may be conducted prior to generating a product offer. In certain embodiments, the performance of a credit analysis may result in a pre-approved product offer being generated, such as a pre-approved loan product offer. As desired, the additional processing (e.g., credit analysis, etc.) may be performed by the financial service provider system 105 and/or by a financial institution system 106. For example, the financial service provider system 105 or the financial institution system 106 may generate a request for a credit check, and the generated request may be communicated to a suitable credit agency. A response to the request may then be received from the credit agency and evaluated in order to determine whether a product offer (or a pre-approved product offer) will be generated.

Additionally, a wide variety of suitable communication channels and/or communication techniques may be utilized to deliver a product offer to the customer. In certain embodiments, a financial institution system and/or financial institution personnel may transmit, communicate, or otherwise deliver a product offer to the customer. In other embodiments, the financial service provider system 105 may transmit, communicate, or otherwise deliver a product offer to the customer. Examples of suitable communication channels that may be utilized to deliver a product offer include, but are not limited to, a financial institution employee (e.g., a bank teller, a customer service representative, etc.) delivering a product offer to the customer at a financial institution location, a telephone call made to a telephone number of the customer, an automated teller machine (ATM) customer channel that presents a product offer during an ATM interaction, “snail” mail of a product offer, email of a product offer to an email account of the customer, short message service (SMS) messaging of a product offer to a telephone number of the customer, and/or an online banking interface or online EBPP interface (e.g., a consumer online banking user interface, a small business online banking user interface, etc.) interaction with the customer that may involve “in application” messaging. In certain embodiments, a wide variety of suitable customer preferences and/or customer criteria may be evaluated in order to determine or identify a suitable customer channel to be utilized.

Additionally, in the event that the financial service provider delivers a product offer to the customer, a customer response to the product offer may be received by the financial service provider or the financial institution. For example, an acceptance or denial of a product offer may be received. As desired, the financial service provider may communicate information associated with the customer response to the financial institution. Alternatively, the financial institution may communicate information associated with the customer response to the financial service provider. Additionally, in certain embodiments, either the financial service provider or the financial institution may facilitate the establishment of a product (e.g., a loan, a credit card, etc.) based upon a received customer acceptance of a product offer.

The method 300 may end following either block 312 or block 332.

The operations described and shown with reference to FIGS. 3A and 3B may be carried out or performed in any suitable order as desired in various embodiments of the invention. Additionally, in certain embodiments, at least a portion of the operations may be carried out in parallel. Furthermore, in certain embodiments, less than or more than the operations described herein may be performed. For example, in one embodiment, a financial service provider system may directly generate a product offer based upon a determination of a customer's candidacy for a financial institution product. In other words, it is not necessary that a product offer proposal be generated.

The invention is described above with reference to block and flow diagrams of systems, methods, apparatus, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. A special-purpose computer may be a general-purpose computer that is programmed to perform one or more of the steps discussed herein. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-readable medium having one or more computer-readable programs embodied therein, wherein said one or more computer-readable programs, upon execution, implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Many modifications and other embodiments of the invention will come to mind to one skilled in the art to which this invention pertains and having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method, comprising:
analyzing, by a payment analysis system comprising one or more computers, historical information associated with a customer of a first financial institution to identify transaction information comprising at least one of (i) a set of one or more payments directed to a second financial institution different from the first financial institution or (ii) a set of one or more bills received from the second financial institution;
determining, by the payment analysis system based at least in part upon an evaluation of the transaction information, a customer candidacy for an offer associated with a first financial institution product;
generating, by the payment analysis system based at least in part upon the determined customer candidacy, an offer proposal for the first financial institution product; and
transmitting, by the payment analysis system, the generated offer proposal to one or more system components associated with the first financial institution for at least one of (i) presentation to an employee of the first financial institution, (ii) further evaluation of the generated offer proposal, (iii) transformation of the generated offer proposal into an offer, or (iv) delivery of the offer to the customer through a customer channel.

2. The method of claim 1, wherein determining a customer candidacy comprises determining a customer candidacy based at least in part upon an identified pattern of recurring payments made by the customer to the second financial institution.

3. The method of claim 1, wherein determining a customer candidacy further comprises:
identifying a set of one or more rules associated with the evaluation of the transaction information; and
determining whether the one or more identified rules are satisfied by the transaction information.

4. The method of claim 3, further comprising:
receiving, by the payment analysis system, at least one of the one or more rules from the first financial institution.

5. The method of claim 3, wherein the set of one or more rules comprises a first set of one or more rules, and further comprising:
identifying, by the payment analysis system, one or more customer indicators associated with the customer,
wherein determining the customer candidacy further comprises evaluating the one or more customer indicators utilizing a second set of one or more rules.

6. The method of claim 5, wherein the one or more customer indicators comprise at least one of (i) a customer segment indication, (ii) an attrition propensity indication, (iii) a customer loyalty, (iv) a customer value indication, (v) an indication of an optimal product to offer to the customer, (vi) a loan candidacy indication, or (vii) an indication of a share of a customer's financial business attributed to the first financial institution.

7. The method of claim 5, wherein at least one of the one or more customer indicators is determined by processing account data associated with the first financial institution utilizing at least one of (i) a predictive model or (ii) a calculation.

8. The method of claim 1, wherein analyzing historical information comprises analyzing at least one of (i) first financial institution account data associated with the customer, (ii) bill payment data associated with the customer, or (iii) electronic billing data associated with the customer.

9. The method of claim 1, wherein analyzing historical information to identify transaction information comprises at least one of (i) processing a payee name or (ii) processing one or more data elements other than the payee name.

10. The method of claim 9, wherein analyzing historical information to identify transaction information comprises processing one or more data elements other than the payee name,
wherein the one or more data elements comprises an account number of the customer at the second financial institution, and
wherein the account number is shared by each item in the transaction information.

11. The method of claim 1, wherein generating an offer proposal further comprises one or more of (i) confirming the eligibility of the customer for the first financial institution product or (ii) customizing one or more parameters of the offer proposal for the customer.

12. The method of claim 11, wherein generating an offer proposal further comprises customizing one or more parameters of the offer proposal for the customer, the one or more parameters including at least one of (i) a loan amount, (ii) a loan interest rate, (iii) a loan period, (iv) a maximum credit amount associated with a credit account, or (v) an interest rate associated with the credit account.

13. The method of claim 1, wherein the customer channel comprises one of (i) a customer service representative of the first financial institution interacting with the customer, (ii) physical mail piece mailing to an address of the customer, (iii) electronic mailing to an email address of the customer, (iv) short message service messaging to a phone number of the customer, (v) voice calling to a phone number of the customer, (vi) an automated teller machine interface, or (vii) an online banking interface.

14. A system, comprising:
at least one memory operable to store computer-executable instructions; and
at least one processor configured to access the at least one memory and execute the computer-executable instructions to:
analyze historical information associated with a customer of a first financial institution to identify transaction information comprising at least one of (i) a set of one or more payments directed to a second financial institution different from the first financial institution or (ii) a set of one or more bills received from the second financial institution;
determine, based at least in part upon an evaluation of the transaction information, a customer candidacy for an offer associated with a first financial institution product;
generate, based at least in part upon the determined customer candidacy, an offer proposal for the first financial institution product; and
direct transmission of the generated offer proposal to one or more system components associated with the first financial institution for at least one of (i) presentation to an employee of the first financial institution, (ii) further evaluation of the generated offer proposal, (iii) transformation of the generated offer proposal into an offer, or (iv) delivery of the offer to the customer through a customer channel.

15. The system of claim 14, wherein the at least one processor is configured to determine the customer candidacy based at least in part upon an identified pattern of recurring payments made by the customer to the second financial institution.

16. The system of claim 14, wherein the at least one processor is configured to determine the customer candidacy by executing the computer-executable instructions to:
identify a set of one or more rules associated with the evaluation of the transaction information; and
determine whether the one or more identified rules are satisfied by the transaction information.

17. The system of claim 16, wherein the set of one or more rules comprises a first set of one or more rules, and wherein the at least one processor is further configured to execute the computer-executable instructions to:
identify one or more customer indicators associated with the customer; and
determine the customer candidacy based at least in part upon an evaluation of the one or more customer indicators utilizing a second set of one or more rules.

18. The system of claim 17, wherein the one or more customer indicators comprise at least one of (i) a customer segment indication, (ii) an attrition propensity indication, (iii) a customer loyalty, (iv) a customer value indication, (v) an indication of an optimal product to offer to the customer, (vi) a loan candidacy indication, or (vii) an indication of a share of a customer's financial business attributed to the first financial institution.

19. The system of claim 17, wherein at least one of the one or more customer indicators is determined by processing account data associated with the first financial institution utilizing at least one of (i) a predictive model or (ii) a calculation.

20. The system of claim 14, wherein the analyzed historical information comprises at least one of (i) first financial institution account data associated with the customer, (ii) bill payment data associated with the customer, or (iii) electronic billing data associated with the customer.

21. A method, comprising:
analyzing, by a payment analysis system comprising one or more computers, historical information associated with a customer of a first financial institution to identify transaction information comprising at least one of (i) a set clone or more payments directed to a second financial institution different from the first financial institution or (ii) a set of one or more bills received from the second financial institution;
determining, by the payment analysis system based at least in part upon an evaluation of the transaction information, a customer candidacy for an offer associated with a first financial institution product;
generating, by the payment analysis system based at least in part upon the determined customer candidacy, an offer for the first financial institution product; and
transmitting, by the payment analysis system, the generated offer to the customer through a customer channel.
